(19) United States
(12) Patent Application Publication
(10) Pub. No.: US 2026/0046908 A1
(43) Pub. Date: Feb. 12, 2026

(54) PROCEDURES OF SENSING RESULTS SHARING FROM LTE SIDELINK TO NR SIDELINK

(71) Applicant: Apple Inc., Cupertino, CA (US)

(72) Inventors: Chunxuan Ye, San Diego, CA (US); Dawei Zhang, Saratoga, CA (US); Zhibin Wu, Los Altos, CA (US); Huaning Niu, San Jose, CA (US); Weidong Yang, San Diego, CA (US); Wei Zeng, Saratoga, CA (US); Seyed Ali Akbar Fakoorian, San Diego, CA (US); Hong He, San Jose, CA (US); Haitong Sun, Cupertino, CA (US); Peng Cheng, Beijing (CN)

(21) Appl. No.: 19/102,913

(22) PCT Filed: Aug. 12, 2022
(86) PCT No.: PCT/CN2022/112125

§ 371 Date: Feb. 11, 2025

(51) Int. Cl. H04W 72/40; H04B 17/318; H04W 72/1263

(52) U.S. Cl. CPC H04W 72/40; H04B 17/328; H04W 72/1263

(57) ABSTRACT

Methods, systems, devices, and computer programs for NR sidelink resource (re)selection using LTE sidelink information are disclosed. In one aspect, the method can include actions of determining, by an NR sidelink module of a UE, a set of NR sidelink resources that overlap with indicated LTE sidelink resources, and excluding, by the NR sidelink module of the UE, the determined set of resources from a candidate resource set (S_{A}) at a predetermined time.

### BACKGROUND

In some wireless communications networks, a user equipment (UE) may communicate with another UE without having the communication routed through a network node, using what is referred to as sidelink communication. A transmitting UE that wants to initiate sidelink communication may determine the available resources (e.g., sidelink resources) and may select a subset of these resources to communicate with a receiving UE based on a resource allocation scheme. Such dynamic resource sharing between two different UEs is referred to as inter-UE sharing.

### SUMMARY

The present disclosure is directed towards system, methods, and computer programs for sensing results sharing from LTE sidelink to NR sidelink of the same UE, which may be referred to as intra-UE information sharing. In particular, the present disclosure is directed towards how an LTE sidelink module is configured to share LTE sidelink sensing results with an NR sidelink module, how the LTE sidelink module shares the LTE sidelink sensing results with an NR sidelink module, and the contents of the LTE sidelink sensing results shared with the NR sidelink module. In addition, the present disclosure is also directed towards how an NR sidelink module uses the LTE sidelink sensing results that the NR sidelink module receives.

According to one innovative aspect of the present disclosure, a method for information sharing between an LTE sidelink module of a UE and an NR sidelink module of the UE is disclosed. In one aspect, the method can include actions of determining, by the NR sidelink module of the UE, that a triggering condition for information sharing has been satisfied, and based on a determination, by the NR sidelink module of the UE, that the triggering condition for information sharing has been satisfied, transmitting, by the NR sidelink module of the UE, an explicit request for LTE sensing results to the LTE sidelink module of the UE.

Other aspects includes apparatuses, systems, and computer programs for performing the actions of the aforementioned method.

The innovative method can include other optional features. For example, in some implementations, the triggering condition can include a determination, by the NR sidelink module of the UE, that a resource selection operation is to be performed.

In some implementations, the triggering condition can include a determination, by the NR sidelink module of the UE, that a resource re-selection operation is to be performed.

In some implementations, the triggering condition can include a determination, by the NR sidelink module of the UE, that a resource re-evaluation or resource preemption operation is to be performed.

In some implementations, transmitting, by the NR sidelink module of the UE, an explicit request for LTE sensing results to the LTE sidelink module of the UE can include transmitting, by the NR sidelink module of the UE, a single explicit request for LTE sensing results to the LTE sidelink module.

In some implementations, transmitting, by the NR sidelink module of the UE, an explicit request for LTE sensing results to the LTE sidelink module of the UE can include periodically transmitting, by the NR sidelink module, an explicit request for LTE sensing results to the LTE sidelink module of the UE.

In some implementations, the method can further include receiving, by the NR sidelink module of the UE, LTE sensing results from the LTE sidelink module in response to the transmitted request for LTE sensing results, interpreting, by the NR sidelink module of the UE, the received LTE sensing results from the LTE sidelink module, and using, by the NR sidelink module of the UE, the interpreted LTE sensing results during the performance of resource selection procedure by the NR sidelink module of the UE.

In some implementations, the method can further include configuring, by the NR sidelink module of the UE, intra-UE information sharing with the LTE sidelink module of the UE.

In some implementations, the NR sidelink module of the UE can interpret the LTE sensing results based on the configuration of intra-UE information sharing with the LTE sidelink module of the UE by the NR sidelink module.

In some implementations, configuring, by the NR sidelink module of the UE, intra-UE information sharing with the LTE sidelink module of the UE can include configuring one or more sensing parameters or one or more resource selection parameters.

In some implementations, the one or more sensing parameters or the one or more resource selection parameters can include a resource allocation mode, sensing window information, RSRP threshold used for determined whether a resource is occupied, resource selection information, data priority, Cresel, or data periodicity.

In some implementations, configuring, by the NR sidelink module of the UE, intra-UE information sharing with the LTE sidelink module of the UE can include configuring information sharing information.

In some implementations, the information sharing information can include information sensing periodicity by the NR sidelink module or LTE sidelink module.

In some implementations, configuring, by the NR sidelink module of the UE, intra-UE information sharing with the LTE sidelink module of the UE can include configuring resource pool related information.

In some implementations, resource pool related information can include a resource pool index, an LTE resource pool configuration, an NR resource pool configuration, or NR sidelink numerology.

In some implementations, contents of the explicit request can include one or more of (i) a time window of LTE sidelink sensing, (ii) a time window of NR sidelink resources selection [n+T1, n+T2], (iii) a latest time when the shared information needs to be received, (iv) an RSRP threshold for determining the occupied resources in LTE sidelink sensing, (v) data priority and periodicity of the NR sidelink transmission, (vi) a number of sub-channels to be used for NR sidelink data transmissions, (vii) a sidelink sub-carrier spacing, (viii) a resource pool index, (ix) Cresel, or (x) information sharing periodicity.

In some implementations, contents of the explicit request can include the same contents as inter-UE coordination scheme 1.

In some implementations, the contents of inter-UE coordination scheme 1 can include (i) SCI format 2-C with the providing requesting indicator field being 1 or (ii) inter-UE coordination request MAC CE.

In some implementations, contents of the LTE sensing results can include one or more of (i) a reference subframe location or (ii) multiple of one or more parameters indicating a set of non-preferred resources from LTE sidelink.

In some implementations, the reference subframe location can include a DEN or subframe index.

In some implementations, the reference subframe is equal to a starting subframe of the resource selection window indicated in the explicit request for LTE sensing results.

In some implementations, the one or more parameters indicating a set of non-preferred resources from LTE sidelink can include: (a) a frequency resource location of initial transmission and retransmission, (b) a lowest index of the sub-channel of the initial transmission, (c) an initial transmission time location, (d) a time gap between initial transmission and retransmission, (e) resource reservation periodicity, (f) a priority, or (g) an RSRP measurement.

In some implementations, the initial transmission time location can include a time offset from reference subframe or a number of slots starting from reference slot/subframe location.

In some implementations, the set of non-preferred resources from LTE sidelink are from (a) the UE's own resource reservation, (b) the UE's resource (re)selection, or (c) another UE's resource reservation.

In some implementations, the non-preferred resources are resources from the LTE sidelink that are occupied.

In some implementations, the contents of LTE sensing results comprise (i) SCI format 2-C with the providing requesting indicator field being 0 or (ii) inter-UE coordination request MAC CE.

In some implementations, the contents of the LTE sensing results indicate that the whole LTE sidelink resource pool(s) are unavailable for NR sidelink transmission.

In some implementations, the method can further include based on a determination, by the NR sidelink module of the UE, that the LTE sensing results indicate that the whole LTE sidelink resource pool(s) are unavailable for NR sidelink transmission, determining, by the NR sidelink module of the UE, to drop the NR sidelink transmission.

According to another innovative aspect of the present disclosure, another method for information sharing between an LTE sidelink module of a UE and an NR sidelink module of the UE is disclosed. In one aspect, the method can include receiving, by the NR sidelink module of the UE, LTE sensing results autonomously provided by the LTE sidelink module of the UE, and interpreting, by the NR sidelink module of the UE, the received LTE sensing results autonomously provided by the LTE sidelink module of the UE.

Other aspects includes apparatuses, systems, and computer programs for performing the actions of the aforementioned method.

The innovative method can include other optional features. For example, in some implementations, the LTE sidelink module of the UE is configured to periodically provide the LTE sensing results to the NR sidelink module of the UE.

In some implementations, the LTE sidelink module of the UE is configured to aperiodically provide the LTE sensing results to the NR sidelink module of the UE.

In some implementations, the LTE sidelink module of the UE is configured to provide the LTE sensing results to the NR sidelink module of the UE in response to a determination that an LTE sidelink channel busy ratio (CBR) has satisfied a predetermined threshold.

In some implementations, the CBR has satisfied the predetermined threshold if the CBR is greater than the predetermined threshold.

In some implementations, the method can further include using, by the NR sidelink module of the UE, the interpreted LTE sensing results during the performance of resource selection procedure by the NR sidelink module of the UE.

In some implementations, the method can further include configuring, by the NR sidelink module of the UE, intra-UE information sharing with the LTE sidelink module of the UE.

In some implementations, the NR sidelink module of the UE interprets the LTE sensing results based on the configuration of intra-UE information sharing with the LTE sidelink module of the UE by the NR sidelink module.

In some implementations, configuring, by the NR sidelink module of the UE, intra-UE information sharing with the LTE sidelink module of the UE can include configuring one or more sensing parameters or one or more resource selection parameters.

In some implementations, the one or more sensing parameters or the one or more resource selection parameters comprises a resource allocation mode, sensing window information, RSRP threshold used for determined whether a resource is occupied, resource selection information, data priority, Cresel, or data periodicity.

In some implementations, configuring, by the NR sidelink module of the UE, intra-UE information sharing with the LTE sidelink module of the UE can include configuring information sharing information.

In some implementations, the information sharing information can include information sensing periodicity by the NR sidelink module or LTE sidelink module.

In some implementations, configuring, by the NR sidelink module of the UE, intra-UE information sharing with the LTE sidelink module of the UE can include configuring resource pool related information.

In some implementations, the resource pool related information can include a resource pool index, an LTE resource pool configuration, an NR resource pool configuration, or NR sidelink numerology.

In some implementations, contents of the LTE sensing results comprise one or more of (i) a reference subframe location or (ii) multiple of one or more parameters indicating a set of non-preferred resources from LTE sidelink.

In some implementations, the reference subframe location comprises a DFN or subframe index.

In some implementations, the reference subframe location is equal to a starting subframe of the resource selection window indicated in the explicit request for LTE sensing results.

In some implementations, the one or more parameters indicating a set of non-preferred resources from LTE sidelink comprise: (a) a frequency resource location of initial transmission and retransmission, (b) a lowest index of the sub-channel of the initial transmission, (c) an initial transmission time location, (d) a time gap between initial transmission and retransmission, (e) resource reservation periodicity, (f) a priority, or (g) an RSRP measurement.

In some implementations, the initial transmission time location can include a time offset from reference subframe or a number of slots starting from reference slot/subframe location.

In some implementations, the set of non-preferred resources from LTE sidelink are from (a) the UE's own resource reservation, (b) the UE's resource (re)selection, or (c) another UE's resource reservation.

In some implementations, the non-preferred resources are resources from the LTE sidelink that are occupied.

In some implementations, the contents of LTE sensing results comprise (i) SCI format 2-C with the providing requesting indicator field being 0 or (ii) inter-UE coordination request MAC CE.

In some implementations, contents of the LTE sensing results indicates that the whole LTE sidelink resource pool(s) are unavailable for NR sidelink transmission.

In some implementations, the method can further include based on a determination, by the NR sidelink module of the UE, that the LTE sensing results indicate that the whole LTE sidelink resource pool(s) are unavailable for NR sidelink transmission, determining, by the NR sidelink module of the UE, to drop the NR sidelink transmission.

According to another innovative aspect of the present disclosure, a method for NR sidelink resource (re)selection using LTE sidelink information is disclosed. In one aspect, the method can include actions of determining, by an NR sidelink module of a UE, a set of NR sidelink resources that overlap with indicated LTE sidelink resources, and excluding, by the NR sidelink module of the UE, the determined set of resources from a candidate resource set (S_{A}) at a predetermined time.

In some implementations, the predetermined time is after the stage of NR resource selection procedure that sets S_{A} to the set of resources in the NR resource selection window.

In some implementations, the predetermined time is after the stage of NR resource selection procedure that excludes candidate resources from S_{A} if the UE did not sense the candidate resources in the sensing window with configured resource reservation periods before a candidate slot.

In some implementations, the predetermined time is after the stage of NR resource selection procedure that determines whether to exclude additional candidate resources from S_{A}, and the stage of NR resource selection that determines whether to exclude additional candidate resources from S_{A} occurs after the stage of the NR resource selection procedure that excludes candidate resources from S_{A} that the UE did not sense in the sensing window with configured resource reservation periods before a candidate slot.

In some implementations, the predetermined time is after the stage of NR resource selection procedure that excludes candidate resources from S_{A} (i) if the UE receives SCI with reservation of the candidate resources and (ii) if RSRP measurement for the candidate resource(s) is higher than the obtained RSRP thresholds.

In some implementations, the predetermined time is after the stage of NR resource selection procedure where the UE determines whether a helper UE has provided or will provide preferred or non-preferred resources.

In some implementations, the predetermined time is after the stage of NR resource selection procedure wherein the UE excludes one or more non-preferred resources, which were provided by a helper via inter-UE coordination information, from S_{A}.

In some implementations, the predetermined time is after the stage of NR resource selection procedure that determines whether a number of resources in S_{A} is smaller than X*Mₜₒₜₐₗ before proceed with the NR resource selection procedure, where Mₜₒₜₐₗ is equal to a number of candidate single-slot resources and X is equal to a configured or preconfigured percentage.

### BRIEF DESCRIPTION OF THE DRAWINGS

FIG. 1 is a flowchart of an example of a process for request-based NR sidelink procedure for considering LTE sidelink sensing results.

FIG. 2 is a flowchart of another example of a process for request based NR sidelink procedure for considering LTE sidelink sensing results.

FIG. 3 is a flowchart of an example of a process for condition-based NR sidelink procedure for considering LTE sidelink sensing results.

FIG. 4 is a flowchart of another example of a process for condition-based NR sidelink procedure for considering LTE sidelink sensing results, in accordance with one aspect of the present disclosure.

FIG. 5 is a flowchart of an example of a process for NR resource selection procedure

FIG. 6 is a diagram of an example of an exclusion of a candidate resource based on LTE sensing results.

FIG. 7 is a flowchart of an example of a process for exclusion of a candidate resource based on LTE sensing results.

FIG. 8 is an example of a wireless communication system.

FIG. 9 is a block diagram of an example of user equipment (UE).

FIG. 10 is a block diagram of an example of an access node.

Like reference symbols in the various drawings indicate like elements.

### DETAILED DESCRIPTION

The present disclosure is directed towards system, methods, and computer programs for sensing results sharing from LTE sidelink to NR sidelink of the same UE, which may be referred to as intra-UE information sharing. In particular, the present disclosure is directed towards how an LTE sidelink module is configured to share LTE sidelink sensing results with an NR sidelink module, how the LTE sidelink module shares the LTE sidelink sensing results with an NR sidelink module, and the contents of the LTE sidelink sensing results shared with the NR sidelink module. In addition, the present disclosure is also directed towards how an NR sidelink module uses the LTE sidelink sensing results that the NR sidelink module receives.

For purposes of this disclosure, an NR sidelink module refers to software modules, hardware modules, or a combination of both, that manage and/or facilitate NR sidelink operations in an NR sidelink network such as sidelink resource selection, sidelink resource utilization including transmission and reception, and sidelink resource sharing. Likewise, an LTE sidelink module refers to software modules, hardware modules, or a combination of both, that manage or facilitate LTE sidelink operations in an LTE V2X network such as sidelink resources selection, sidelink resource utilization including transmission and reception, and sidelink resources sharing.

In some implementations, the NR sidelink module and the LTE sidelink module can be implemented in separate modules. For example, in some implementations, each of the respective sidelink modules can be implemented as, or part of, different communications modules that are configured to realize the functionality attributed to each respective sidelink module herein. In such implementations, it is possible to have not just a logical difference between the two sidelink modules, but also a physical difference in, for example, the hardware components used to implement the respective sidelink modules.

However, the present disclosure is not so limited. Instead, in some implementations, the NR sidelink module and the LTE sidelink module can be implemented in a single module. For example, in some implementations, both the NR sidelink module and the LTE sidelink module can be implemented in a single communications module. In such implementations, the NR sidelink module and the LTE sidelink module are each still capable of realizing the functionality attributed to each respective sidelink module herein. However, in this latter implementation where both the NR sidelink module and the LTE sidelink module are implemented in a single module, the distinction between the NR sidelink module and the LTE sidelink module may be more of a logical difference between the two respective sidelink modules than a physical difference in device components used to implement the respective sidelink modules.

In view of the above, the term “transmitting” as used herein is not limited to only transmitting of information externally from a UE in, for example, over the air transmissions. Instead, the term “transmitting” should be viewed more broadly to include, for example, communications of data that may be fully, or partially, internal to a UE. Accordingly, for purposes of the present disclosure, the term “transmitting” is intended to be broad enough to cover communications between two modules within the same UE, without the need for over the air transfer of data, regardless of whether the two modules are independent physical modules of the UE or two (or more) modules that, though physically implemented using a single module, are logically separate, but within, the UE. That said, nothing in the present disclosure should prohibit the scope of “transmitting” from also covering communications external to a UE, if such external communications also fall within the scope accompanying claims. For purposes of this disclosure, a module is intended to include software modules, hardware modules, or a combination of both, that are used to realize the functionality of the module attributed to by the present disclosure.

Request-Based Information Sharing from LTE SL Module to NR SL Module

Request-based information sharing from LTE sidelink (SL) module to NR SL module can include use one or more triggers, when met, cause the NR SL module to transmit a request, referred to herein as an explicit request, for information sharing to the LTE sidelink module. The request for information sharing calls for LTE sensing results. The request for information sharing can be triggered when performing resource selection, resource re-selection, resource evaluation, resource pre-emption, or any combination thereof. The request for information sharing from the NR SL module to the LTE SL module can be a single, one-shot request for information sharing. Alternatively, the request for information sharing from the NR SL module to the LTE SL module can be periodical.

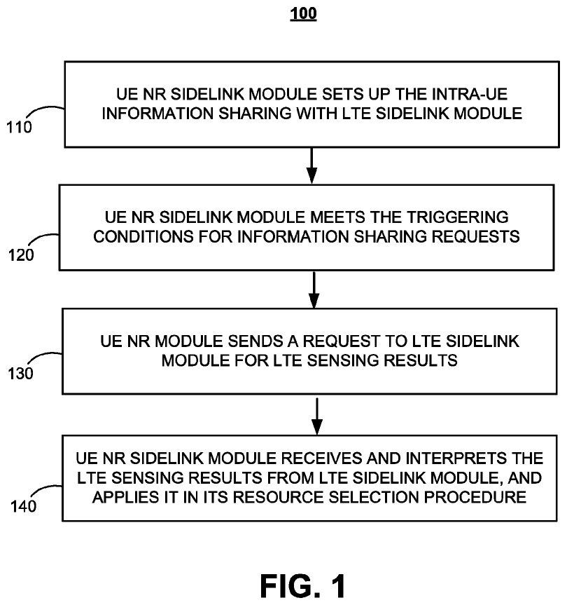

FIG. 1 is a flowchart of an example of a process 100 for request-based NR sidelink procedure for considering LTE sidelink sensing results.

Execution of the process 100 begins when a UE NR sidelink module sets up the intra-UE information sharing with an LTE sidelink module (110). The UE NR sidelink module meets the triggering conditions for information sharing request (120). The UE NR sidelink module sends a request to LTE sidelink module for LTE sensing results (130). The UE NR sidelink module receives and interprets the LTE sensing results from the LTE sidelink module, and applies it in its resource selection procedure (140).

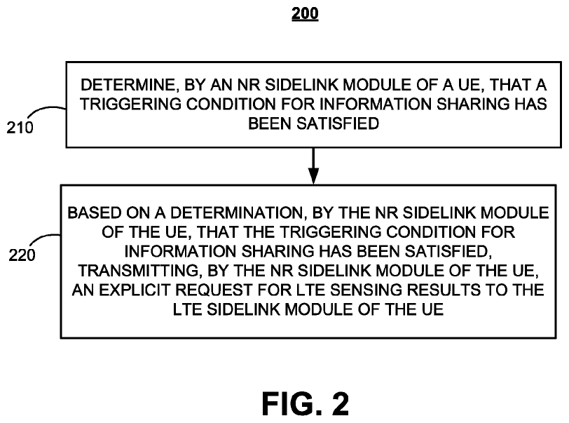

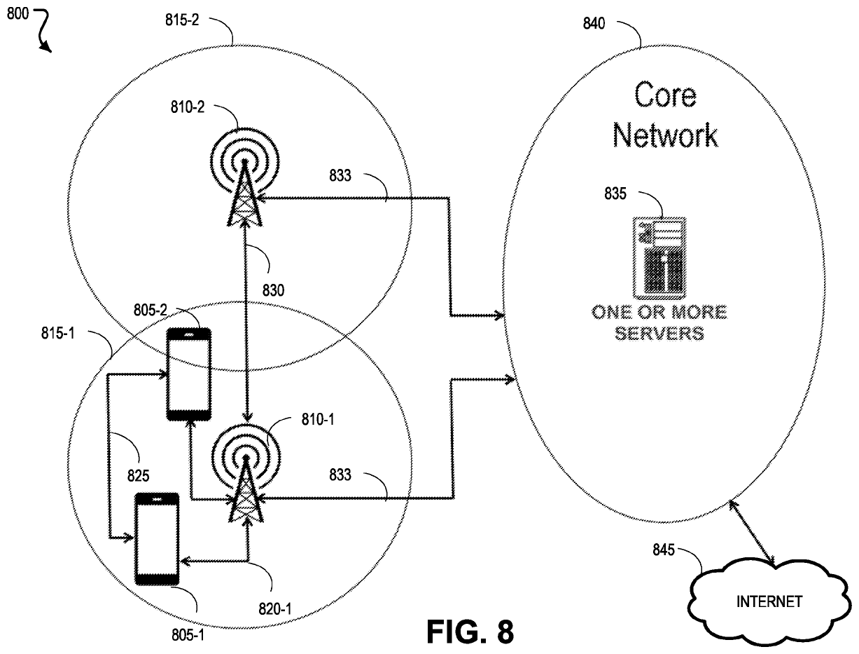

FIG. 2 is a flowchart of another example of a process 200 for request based NR sidelink procedure for considering LTE sidelink sensing results. The process 200 will be described as being performed by an NR sidelink module of a UE. An example of the UE is UE 805 of FIG. 8.

An NR sidelink module of a UE can begin execution of the process 200 by determining that a triggering condition for information sharing has been satisfied (210). In some implementations, the triggering condition can include a determination, by the NR sidelink module of the UE, that a resource selection operation is to be performed. In some implementations, the triggering condition can include a determination, by the NR sidelink module of the UE, that a resource reselection operation is to be performed. In some implementations, the triggering condition can include a determination, by the NR sidelink module of the UE, that a resource re-evaluation or resource preemption operation is to be performed.

Then, based on a determination by the NR sidelink module of the UE that the triggering condition for information sharing has been satisfied, the NR sidelink module of the UE can transmit an explicit request for LTE sensing results to the LTE sidelink module of the UE (220). In some implementations, the transmitting stage 210 can include the NR sidelink module of the UE transmitting a single explicit request for LTE sensing results to the LTE sidelink module. In other implementations, the transmitting stage 210 can include the NR sidelink module of the UE periodically transmitting, by the NR sidelink module, an explicit request for LTE sensing results to the LTE sidelink module of the UE.

In some implementations, the NR sidelink module of the UE can continue execution of the process 200 by receiving LTE sensing results from the LTE sidelink module in response to the transmitted request for LTE sensing results. In such implementations, the NR sidelink module can continue execution of the process 200 by interpreting the received LTE sensing results from the LTE sidelink module. In such implementations, the NR sidelink module can continue execution of the process 200 by using the interpreted LTE sensing results during the performance of resource selection procedure by the NR sidelink module of the UE.

### Configuration of Intra-UE Sidelink Information Sharing

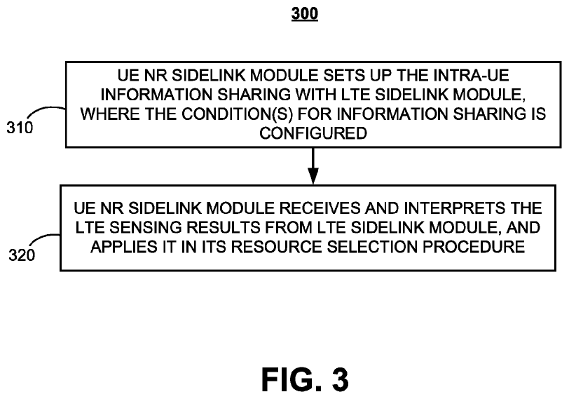

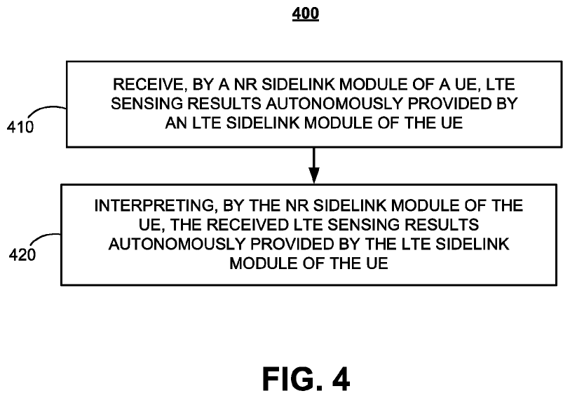

The NR sidelink module of the UE can configure intra-UE information sharing with the LTE sidelink module. This configuration stage is described in FIG. 1, 110 and FIG. 3, 310. Likewise, in some implementations, the NR sidelink module of the UE can configure the inter-UE information sharing processes described herein with respect to the processes of FIG. 2, 200 and FIG. 4, 400.

In some implementations, the NR sidelink module can configure one or more sensing and resource selection parameters of the LTE sidelink module. The sensing and resource selection parameters of the LTE sidelink module that can be configured can include the resource allocation mode, the sensing window information, resources selection information, data priority, Cresel, or data periodicity.

The resource allocation mode can include, for example, mode 1 or mode 2 in NR sidelink module or mode 3 or mode 4 in LTE sidelink module.

The sensing window information can include sending window length, sensing window starting time, sensing window periodicity, and an RSRP threshold in determining whether a resource within the sensing window is occupied. In some implementations, the RSRP threshold may depend on data priority. In some implementations, the RSRP threshold may be (pre) configured per the NR sidelink resource pool.

The resource selection information can include a length, a starting time, or a periodicity.

In some implementations, the NR sidelink module can configure the intra-UE sharing procedure to share at least some information sharing information. The information sharing information that may be shared can include information sharing periodicity.

In some information, the NR sidelink module can configure the intra-UE sharing procedure to share at least some resource pool related information. The resource pool related information can include a resource pool index, an LTE resource pool configuration, an NR resource pool configuration, or an NR sidelink numerology.

The LTE resource pool configuration can include, for example, a sub-channel size, starting PRBs, or a resource reservation periodicity.

The NR resource pool configuration can include, sub-channel size, starting PRBs, resource or reservation periodicity.

The NR sidelink numerology can include, for example, a sidelink BWP configuration.

Interpretation Received LTE Sensing Results from LTE Sidelink Module

The NR sidelink module of the UE interprets the received LTE sensing results from LTE sidelink module based on the configuration of the intra-UE information process at FIG. 1, 110 and FIG. 3, 310. Likewise, in some implementations, the NR sidelink module of the UE can interpret LTE sensing results from the LTE sidelink module in the processes of FIG. 2, 200 and FIG. 4, 400 based on the same configuration of the intra-UE information sharing process.

For example, the LTE and NR resource pool configurations including their respective sub-channel size, PRB locations of the resource pool, or the like, as configured during the configuration stage is also used to interpret the received LTE sensing results.

In addition, handling of NR SL sub-channel partial overlap with LTE SL sub-channel is also based on the configuration of the intra UE information sharing process.

### Optional Continuation of Process 200

In some implementations, the NR sidelink module can continue execution of the process 200 by configuring the intra-UE information sharing with the LTE sidelink module of the UE.

In some implementations, the configuration stage of process 200 can include the NR sidelink module configuring one or more sensing parameters or one or more resource selection parameters related to the intra-UE information sharing with the LTE sidelink. In such implementations, the one or more sensing parameters or the one or more resource selection parameters comprises a resource allocation mode, sensing window information, RSRP threshold used for determined whether a resource is occupied, resource selection information, data priority, Cresel, or data periodicity.

In some implementations, the configuration stage of process 200 can include the NR sidelink module configuring information sharing information. In such implementations, the information sharing information comprises information sensing periodicity by the NR sidelink module or LTE sidelink module.

In some implementations, the configuration stage of process 200 can include the NR sidelink module configuring resource pool related information. In such implementations, the resource pool related information can include a resource pool index, an LTE resource pool configuration, an NR resource pool configuration, or NR sidelink numerology.

In some implementations, the NR sidelink module of the UE interprets the LTE sensing results based on the configuration of intra-UE information sharing with the LTE sidelink module of the UE by the NR sidelink module described above.

Though the aforementioned configuration and interpretation processes was described above as an optional extension of the process 200 of FIG. 2, the present disclosure is not so limited. Instead, the aforementioned configuration and interpretation process can also be optionally performed as part of the stage 110 of FIG. 1, stage 310 of FIG. 3, or as part of the process 400 of FIG. 4.

### Contents of Explicit Request for Information of Processes 100 and 200

The request-based processes of FIG. 1, 100 and FIG. 2, 200 each have a stage of the process that submits an explicit request for LTE sensing results. For example, stage 130 of FIG. 1 and stage 220 of FIG. 2 employ an explicit request for LTE sensing results. In contrast, the contents of the explicit request for LTE sensing results are not applicable to the process 300 or the process 400 of FIG. 4, as the processes 300 and 400 do not employ an explicit request. The contents of this explicit request of processes 100 and 200 are described in more detail below.

The content of the explicit request for information sharing of stage 130 and stage 220 can include one or any combination of (i) a time window of LTE sidelink sensing, (ii) a time window of NR sidelink resource selection [n+T₁,n+T₂], (iii) the latest time when the shared information needs to be received, (iv) an RSRP threshold for determining the occupied resources in LTE sidelink sensing, (v) data priority and periodicity of the NR sidelink sensing, (vi) a number of sub-channels to be used for NR sidelink data transmissions, (vii) a sidelink sub-carrier spacing, (viii) a resource pool index, (ix) Cresel, or (x) information sharing periodicity.

Alternatively, in some implementations, the content of the explicit request for information sharing of stage 130 and stage 200 can include the same contents as in inter-UE coordination scheme 1. These contents can include SCI Format 2-C with the providing requesting indicator field being 1 or inter-UE coordination request MAC CE.

### Optional Continuation of Process 200

In some implementations, the contents of the explicit request of process 200 can include one or more of (i) a time window of LTE sidelink sensing, (ii) a time window of NR sidelink resources selection [n+T1, n+T2], (iii) a latest time when the shared information needs to be received, (iv) an RSRP threshold for determining the occupied resources in LTE sidelink sensing, (v) data priority and periodicity of the NR sidelink transmission, (vi) a number of sub-channels to be used for NR sidelink data transmissions, (vii) a sidelink sub-carrier spacing, (viii) a resource pool index, (ix) Cresel, or (x) information sharing periodicity.

In some implementations, the contents of the explicit request of process 200 can include the same contents as inter-UE coordination scheme 1.

In some implementations, the contents of the inter-UE coordination scheme 1 can include (i) SCI format 2-C with the providing requesting indicator field being 1 or (ii) inter-UE coordination request MAC CE.

### Contents of the Shared Information

The processes 100 of FIG. 1, 200 of FIG. 2, 300 of FIG. 3, and 400 of FIG. 4 are directed towards sharing of LTE sidelink information in the form of LTE sensing results with the NR sidelink module. The LTE sensing results are received by the NR sidelink module and from the LTE sidelink module in stages 140 of FIG. 1, 220 of FIG. 2, 320 of FIG. 3, and 420 of FIG. 4. The contents of these LTE sensing results are described in more detail below.

The contents of the shared LTE sensing results can include one or more of (i) reference subframe location and (ii) multiple of one or more of following to indicate the non-preferred resources from LTE sidelink: (a) frequency resource location of initial transmission and retransmission, (b) lowest index of the sub-channel of the initial transmission, (c) initial transmission time location, (d) time gap between initial transmission and retransmission, (e) resource reservation periodicity, (f) priority, (g) RSRP measurement, (h) the non-preferred resources may be from other UE's reservation (by SCI decoding) or from the device's own resource reservation or resource (re)selection.

In some implementations, the reference subframe location can include DFN and subframe index. In some implementations, the reference subframe location may be equal to the starting subframe of the resource selection window indicated in the request of information sharing.

In some implementations, the initial transmission time location can be (i) indicated in a time offset (from reference subframe), (ii) indicated in the unit of number of slots starting from reference slot/subframe location, or (iii) may be ignored for the first indicated resource.

In some implementations, a non-preferred resource may include a reserved resource.

Alternatively, in some implementations and instead of the information described above, the LTE sensing results can include the same contents as in inter-UE coordination scheme 1. The contents of the inter-UE coordination scheme 1 can include SCI Format 2-C with a providing requesting indicator field being set to 0 or inter-UE coordination information MAC CE.

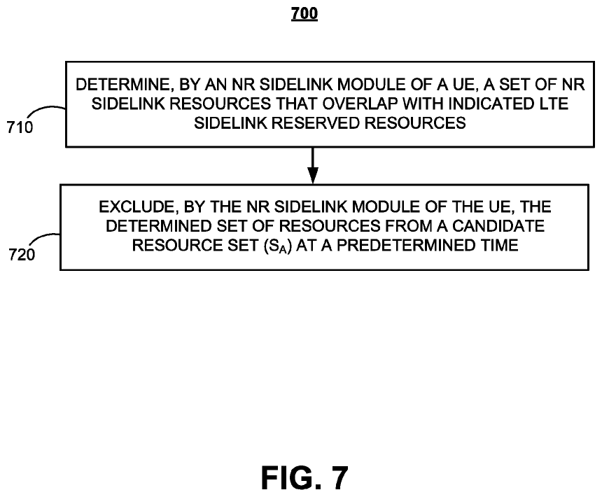

Additionally, in some implementations, it is possible that LTE sensing results indicate that the whole resource pool(s) are unavailable for NR sidelink transmissions. Upon receiving such LTE sensing results, with certain timeline restriction (See process 700 of FIG. 7), the NR sidelink module can drop the NR sidelink transmission.

### Optional Continuation of Process 200

In some implementations, contents of the LTE sensing results received in stage 220 can include one or more of (i) a reference subframe location or (ii) multiple of one or more parameters indicating a set of non-preferred resources from LTE sidelink. In such implementations, the reference subframe location can include a DEN or subframe index. In some implementations, the reference subframe is equal to a starting subframe of the resource selection window indicated in the explicit request for LTE sensing results.

In some implementations, the one or more parameters indicating a set of non-preferred resources from LTE sidelink can include: (a) a frequency resource location of initial transmission and retransmission, (b) a lowest index of the sub-channel of the initial transmission, (c) an initial transmission time location, (d) a time gap between initial transmission and retransmission, (e) resource reservation periodicity, (f) a priority, or (g) an RSRP measurement.

In some implementations, the initial transmission time location can include a time offset from reference subframe or a number of slots starting from reference slot/subframe location.

In some implementations, the set of non-preferred resources from LTE sidelink are from (a) the UE's own resource reservation, (b) the UE's resource (re)selection, or (c) another UE's resource reservation.

In some implementations, the non-preferred resources are resources from the LTE sidelink that are occupied.

In some implementations, the contents of LTE sensing results comprise (i) SCI format 2-C with the providing requesting indicator field being 0 or (ii) inter-UE coordination request MAC CE.

In some implementations, the contents of the LTE sensing results indicates that the whole LTE sidelink resource pool(s) are unavailable for NR sidelink transmission. In such implementations, based on a determination, by the NR sidelink module of the UE, that the LTE sensing results indicate that the whole LTE sidelink resource pool(s) are unavailable for NR sidelink transmission, the NR sidelink module of the UE can determine to drop the NR sidelink transmission.

Though the aforementioned contents of the LTE sensing results were described above as an optional extension of the process 200 of FIG. 2, the present disclosure is not so limited. Instead, the aforementioned description of the LTE sensing results can also optionally apply to stage 140 of FIG. 1, stage 320 of FIG. 3, or stage 420 of FIG. 4.

### Condition-Based Information Sharing From LTE SL Module to NR SL Module

Condition-based LTE sensing result sharing is a process where the LTE sidelink module autonomously triggers transmission of LTE sensing results to the NR sidelink module. In such implementations, no explicit request for LTE sensing results from the NR sidelink module is made to the LTE sidelink module. Instead, the autonomous triggers that cause the LTE sidelink module to transmit LTE sensing results are condition-based. Such conditions include periodic triggering of the transmission of LTE sensing results by the LTE sidelink module or aperiodic triggering of the transmission of LTE sensing results by the LTE sidelink module. In some implementations, aperiodic triggering of the transmission of LTE sensing results by the LTE sidelink module can include triggering transmission of LTE sensing results when LTE sidelink channel busy ratio (CBR) is higher than a threshold.

For purposes of this disclosure, the term “autonomously triggering” is intended to mean triggered independent of a request for LTE sensing results from an NR sidelink module.

FIG. 3 is a flowchart of an example of a process 300 for condition-based NR sidelink procedure for considering LTE sidelink sensing results.

Execution of the process 300 begins when a UE NR sidelink module sets up the intra-UE information sharing with LTE sidelink module, where the condition(s) for information sharing is configured (310).

The UE NR sidelink module can continue execution of the process 300 by receiving and interpreting the LTE sensing results from LTE sidelink module, and then apply it in its resource selection procedure (320).

FIG. 4 is a flowchart of another example of a process 400 for condition-based NR sidelink procedure for considering LTE sidelink sensing results. The process 400 will be described as being performed by an NR sidelink module of a UE. An example of the UE is UE 805 of FIG. 8.

The NR sidelink module of the UE can being execution of the process 400 by receiving LTE sensing results autonomously provided by an LTE sidelink module of the UE (410). In some implementations, the LTE sidelink module of the UE is configured to periodically provide the LTE sensing results to the NR sidelink module of the UE. In other implementations, the LTE sidelink module of the UE is configured to aperiodically provide the LTE sensing results to the NR sidelink module of the UE. In some implementations, aperiodic triggering can include transmission of LTE sensing results when LTE sidelink channel busy ratio (CBR) is higher than a threshold.

The NR sidelink module of the UE can continue execution of the process 400 by interpreting the received LTE sensing results autonomously provided by the LTE sidelink module of the UE (420).

In some implementations, the NR sidelink module can continue execution of the process 400 by using the interpreted LTE sensing results during the performance of resource selection procedure by the NR sidelink module of the UE.

As shown above, the process 400 includes receipt of LTE sensing results. The contents

of the LTE sensing results are described above and can be optionally incorporated as features of the process 400. Likewise, the NR sidelink module's configuration of the intra-UE information sharing process described above can also be included as optional features of process 400.

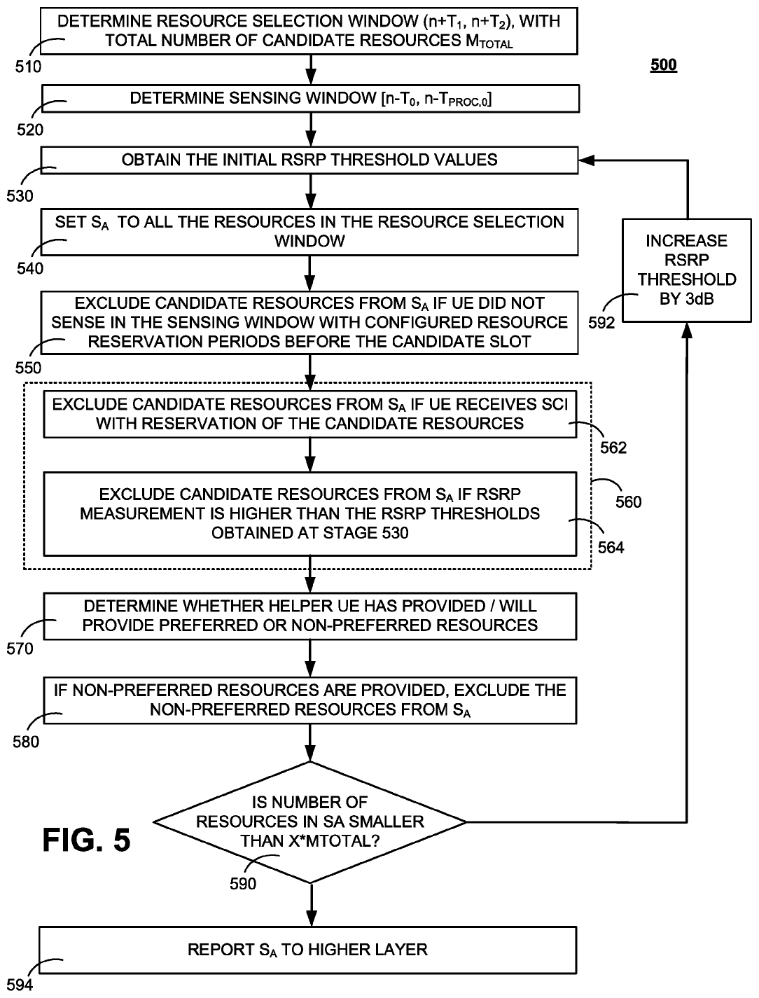

FIG. 5 is a flowchart of an example of a process 500 for NR resource selection procedure. The process 500 is based on NR V2X R16 and is described in more detail in TS 38.214, Section 8.1.4. The process 500 is provided such that it can be used as a reference for relatively timing of the exclusion of candidate resources from a candidate resource for sidelink resources selection as described with reference to process 700 of FIG. 7. The process 500 will be described as being performed by a UE (e.g., a TX UE or transmission UE) such as a UE 805 of FIG. 8. In other implementations, UE may be helper UE or UE-A in an inter-UE coordination (IUC) resources sharing operation, in which case UE 805 of FIG. 8 is still exemplary.

A UE can begin execution of the process 500 by determining a resource selection window (n+T₁, n+T₂), with total number of candidate resources Mₜₒₜₐₗ (510). In this example, n is the time slot for triggering the resource selection/re-evaluation/pre-emption.

The selection of T₁ is up to UE implementation under 0≤T₁≤T_{proc,1}^{SL}, where T_{proc,1}^{SL} is defined in slots in Table 1 where μ_{SL} is the SCS configuration of the SL BWP. If T₂ₘᵢₙ is shorter than the remaining packet delay budget (in slots) then T₂ is up to UE implementation subject to T₂ₘᵢₙ≤T₂≤remaining packet delay budget (in slots); otherwise T₂ is set to the remaining packet delay budget (in slots). In this example, T2min is an internal parameter set to the corresponding value from higher layer parameter “sl-SelectionWindowList” for the given value of prio_TX.

TABLE 1
${T}_{proc , 1}^{SL} depending on sub - carrier spacing$

| μ_{SL} | ${T}_{proc , 1}^{SL} [ slots ]$ |
|---|---|
| 0 | 3 |
| 1 | 5 |
| 2 | 9 |
| 3 | 17 |

The UE can continue execution of the process 500 by determining a sensing window [n-T₀, n-T_{proc,0}) (520), where T₀ is configured and T_{proc,0}^{SL} is defined in slots in Table 2 where μ_{SL} is the SCS configuration of the SL BWP.

TABLE 2
${T}_{proc , 0}^{SL} depending on sub - carrier spacing$

| μ_{SL} | ${T}_{proc , 0}^{SL} [ slots ]$ |
|---|---|
| 0 | 1 |
| 1 | 1 |
| 2 | 2 |
| 3 | 4 |

The UE can continue execution of the process 500 by obtaining the initial RSRP threshold value(s) (530).

The UE can continue execution of the process 500 by setting S_{A} to each of the resources in the resource selection window (540), where S_{A} is the set of candidate resources for resource selection.

The UE can continue execution of the process 500 by excluding candidate resources from S_{A} if UE did not sense in sensing window with configured resource reservation periods before the candidate slot (550).

The UE can continue execution of the process 500 by determining whether there are additional candidate resources to exclude from S_{A} (560). Determining whether there are additional candidate resources to exclude can include excluding candidate resource(s) from S_{A} (i) if UE receives SCI with reservation of the candidate resources (562) and (ii) if RSRP measurement for the candidate resource(s) is higher than the RSRP thresholds obtained at stage 530 (564). In some implementations, the determination as to whether to exclude one or more candidate resources from S_{A} at stage 564 can also be dependent on data priority level of the reserving SCI. For example, the determination at stage 564 can be performed using different RSRP thresholds based on the data priority level.

The UE can continue execution of the process 500 by determining whether a helper UE has provided or will provide preferred or non-preferred resources (570). A helper UE can include, for example, a UE-A that can help the UE via inter-UE coordination (IUC) sharing of resources. In the context of inter-UE coordination (IUC) sharing of resources between the helper UE (UE-A) and the UE, the UE would be a UE-B.

The UE can continue execution of the process 500 determining if non-preferred resources were indicated by the helper UE and, if the helper UE provided non-preferred resources, the UE can exclude the non-preferred resources from S_{A} (580).

The UE can continue execution of the process 500 by determining whether a number of resources in S_{A} is smaller than X*Mₜₒₜₐₗ (590). Based on a determination at 590 that the number of resources in S_{A} is smaller than X*Mₜₒₜₐₗ, the UE can continue execution of the process 500 by increasing 3 dB on RSRP threshold 592 and continuing execution of the process 500 at stage 530. Alternatively, if at stage 590 the UE determines that the number of resources in S_{A} is not smaller than X*Mₜₒₜₐₗ, then UE can conclude the process 500 by reporting S_{A} to a higher layer (594).

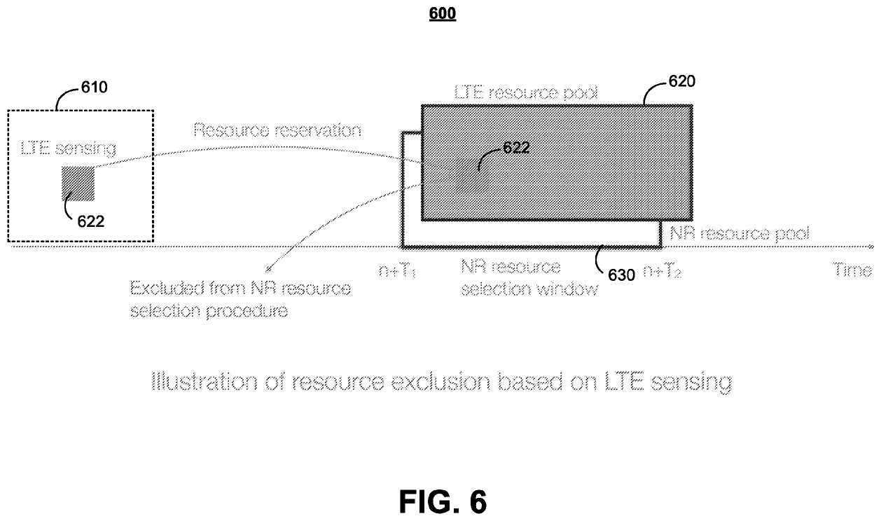

FIG. 6 is a diagram 600 of an example of an exclusion of a candidate resource based on LTE sensing results. Exclusion of candidate resource based on LTE sensing results can occur, e.g., in stage 140 of FIG. 1, 220 of FIG. 2, 320 of FIG. 3, and 420 of FIG. 4.

With reference to FIG. 6, an LTE sidelink module can use a resource sensing window 610 to determine an availability of resources in an LTE resource pool 620. In the example of FIG. 6, the availability of a resource can include whether or not the resource is reserved. The LTE sidelink module can begin the process of LTE sensing responsive to either an explicit request (e.g., process 100 of FIG. 1 or process 200 of FIG. 2) or autonomously based on a trigger condition being met (e.g., process 300 of FIG. 3 or process 400 of FIG. 4).

The LTE sidelink module can provide LTE sensing results that include sensing window information and information related to the LTE resource pool 620 such as a time window of LTE sidelink sensing 610, a time window of NR sidelink resource selection [n+T₁, n+T₂], a resource pool index, and the like.

The NR sidelink module can interpret the received LTE sensing results to determine an availability of LTE resources in the LTE resource pool 620 for resource selection within the NR resource selection window 630. Interpretation of the received LTE sensing results can include, for example, an identification of NR sidelink resources that overlap in time and frequency with indicated LTE sidelink reserved resources. In this example, the resource 622 is reserved in LTE resource pool 620 during the NR resource selection window 630. Accordingly, in such implementations, the LTE sidelink reserved resource 622 is excluded from the candidate resources set that is to be used by the NR sidelink module for resources selection.

### NR Sidelink Resource (Re)Selection With LTE Sidelink Information

NR sidelink resource (re)selection with LTE sidelink sensing results occurs in stage 140 of FIG. 1, 220 of FIG. 2, 320 of FIG. 3, and 420 of FIG. 4. Overall, in NR sidelink resource (re)selection procedure, the NR sidelink resources with overlap in time and frequency with indicated LTE sidelink reserved resources are to be excluded from the candidate resource set. These NR resources with overlap in time and frequency with indicated LTE sidelink reserved resources may be referred to herein as the determined overlapping resources. The same resource exclusion described herein is also applicable to NR sidelink resource re-evaluation or pre-emption checking procedures.

Once such overlapping resources are determined, the NR sidelink module physical layer excludes the determined overlapping resources from a set of candidate resources during NR resource selection (e.g., process 500 of FIG. 5) at a predetermined time. In some implementations, for example, the determined overlapping resources can be excluded from the set of candidate resources for resource selection after stage 540 of FIG. 5, which corresponds to step (4) of TS 38.214, section 8.1.4.

In some implementations, for example, the determined overlapping resources can be excluded from the set of candidate resources for resource selection after stage 550 of FIG. 5, which corresponds to step (5) of TS 38.214, section 8.1.4.

In some implementations, for example, the determined overlapping resources can be excluded from the set of candidate resources for resource selection after stage 560 of FIG. 5, which corresponds to step (6) of TS 38.214, section 8.1.4.

In some implementations, for example, the determined overlapping resources can be excluded from the set of candidate resources for resource selection after stage 570 of FIG. 5, which corresponds to step (6a) of TS 38.214, section 8.1.4.

In some implementations, for example, the determined overlapping resources can be excluded from the set of candidate resources for resource selection after stage 580 of FIG. 5, which corresponds to step (6b) of TS 38.124, section 8.1.45.

In some implementations, for example, the determined overlapping resources can be excluded from the set of candidate resources for resource selection after stage 590 of FIG. 5, which corresponds to step (7) of TS 38.214, Section 8.1.4

If it is not possible to meet the requirement that the number of candidate single-slot resources remaining in the set S_{A} be at least X·Mₜₒₜₐₗ after excluding resource(s) overlapping with the LTE sidelink shared information, it is up to UE implementation whether or not to take into account the received shared information to meet such requirement.

FIG. 7 is a flowchart of an example of a process 700 for exclusion of a candidate resource based on LTE sensing results. The process 700 will be described as being performed by an NR sidelink module of a UE. An example of the UE is UE 805 of FIG. 8.

An NR sidelink module of a UE can begin execution of the process 700 by determining a set of NR sidelink resources that overlap with indicated LTE sidelink resources (710).

The NR sidelink module of the UE can continue execution of the process 700 by excluding the determined set of resources from a candidate resource set (S_{A}) at a predetermined time (720).

In some implementations, the predetermined time is after the stage of NR resource selection procedure that sets S_{A} to the set of resources in the NR resource selection window.

In some implementations, the predetermined time is after the stage of NR resource selection procedure that excludes candidate resources from S_{A} if the UE did not sense the candidate resources in the sensing window with configured resource reservation periods before a candidate slot.

In some implementations, the predetermined time is after the stage of NR resource selection procedure where the UE determines to exclude candidate resources from S_{A} (i) if the UE receives SCI with reservation of the candidate resources and (ii) if RSRP measurement for the candidate resource(s) is higher than the obtained RSRP thresholds.

In some implementations, the predetermined time is after the stage of NR resource selection procedure where the UE determines whether a helper UE has provided or will provide preferred or non-preferred resources.

In some implementations, the predetermined time is after the stage of NR resource

selection procedure wherein the UE excludes one or more non-preferred resources, which were provided by a helper via inter-UE coordination information, from S_{A}. In some implementations, the predetermined time is after the stage of NR resource selection procedure that determines whether a number of resources in S_{A} is smaller than X*Mₜₒₜₐₗ before proceed with the NR resource selection procedure, where Mₜₒₜₐₗ is equal to a number of candidate single-slot resources and X is equal to particular percentage. In some implementations, X may have a possible value of 20%, 30% or 50%, where the value of X is configured by resource pool. In some implementations, different X values may be configured depending on data priority value (“prio_TX”).

FIG. 8 is a diagram of an example of a wireless communication system 800, according to some implementations. It is noted that the system of FIG. 8 is merely one example of a possible system, and that features of this disclosure may be implemented in other wireless communication systems.

The following description is provided for an example communication system 800 that operates in conjunction with fifth generation (5G) networks as provided by 3rd Generation Partnership Project (3GPP) technical specifications (TS). However, the example implementations are not limited in this regard and the described implementations may apply to other networks that may benefit from the principles described herein, such as 3GPP Long Term Evolution (LTE) networks, Wi-Fi or Worldwide Interoperability for Microwave Access (WiMaX) networks, and the like. Furthermore, other types of communication standards are possible, including future 3GPP systems (e.g., Sixth Generation (6G)) systems, IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

As shown, the communication system 800 includes a number of user devices. As used herein, the term “user devices” may refer generally to devices that are associated with mobile actors or traffic participants in the communication system 800, e.g., mobile (able-to-move) communication devices such as vehicles and pedestrian user equipment (PUE) devices. More specifically, the V2X communication system 800 includes two UEs 805 (UE 805-1 and UE 805-2 are collectively referred to as “UE 805” or “UEs 805”), two base stations 810 (base station 810-1 and base station 810-2 are collectively referred to as “base station 810” or “base stations 810”), two cells 815 (cell 815-1 and cell 815-2 are collectively referred to as “cell 815” or “cells 815”), and one or more servers 835 in a core network (CN) 840 that is connected to the Internet 845.

As shown, certain user devices may be able to conduct communications with one another directly, i.e., without an intermediary infrastructure device such as base station 810-1. As shown, UE 805-1 may conduct communications (e.g., V2X-related communications) directly with UE 805-2. Similarly, the UE 805-2 may conduct communications directly with UE 805-2. Such peer-to-peer communications may utilize a “sidelink” interface such as a PC5 interface. In certain implementations, the PC5 interface supports direct cellular communication between user devices (e.g., between UEs 805), while the Uu interface supports cellular communications with infrastructure devices such as base stations. For example, the UEs 805 may use the PC5 interface for a radio resource control (RRC) signaling exchange between the UEs. The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

The PC5 interface may alternatively be referred to as a SL interface and may include one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH). In some examples, the SL interface can operate on an unlicensed spectrum (e.g., in the unlicensed 5 Gigahertz (GHz) and 6 GHz bands) or a (licensed) shared spectrum.

In some implementations, UEs 805 may be physical hardware devices capable of running one or more applications, capable of accessing network services via one or more radio links 820 with a corresponding base station 810, and capable of communicating with one another via sidelink 825. Link 820 may allow the UEs 805 to transmit and receive data from the base station 810 that provides the link 820. The sidelink 825 may allow the UEs 805 to transmit and receive data from one another. The sidelink 825 between the UEs 805 may include one or more channels for transmitting information from UE 805-1 to UE 805-2 and vice versa and/or between UEs 805 and UE-type RSUs (not shown in FIG. 8) and vice versa.

In some implementations, the channels may include the Physical Sidelink Broadcast Channel (PSBCH), Physical Sidelink Control Channel (PSCCH), Physical Sidelink Discovery Channel (PSDCH), Physical Sidelink Shared Channel (PSSCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. The SCI in NR V2X is transmitted in two stages. The 1st-stage SCI in NR V2X is carried on the PSCCH while the 2nd-stage SCI is carried on the corresponding PSSCH. For example, 2-stage SCI can be used by applying the 1^{st} SCI for the purpose of sensing and broadcast communication, and the 2^{nd} SCI carrying the remaining information for data scheduling of unicast/groupcast data transmission.

In some implementations, the sidelink 825 is established through an initial beam pairing procedure. In this procedure, the UEs 805 identify (e.g., using a beam selection procedure) one or more potential beam pairs that could be used for the sidelink 825. A beam pair includes a transmitter beam from a transmitter UE (e.g., UE 805-1) to a receiver UE (e.g., UE 805-2) and a receiver beam from the receiver UE to the transmitter UE. In some examples, the UEs 805 rank the one or more potential beam pairs. Then, the UEs 805 select one of the one or more potential beam pairs for the sidelink 825, perhaps based on the ranking.

As stated, the air interface between two or more UEs 805 or between a UE 805 and a UE-type RSU (not shown in FIG. 8) may be referred to as a PC5 interface. To transmit/receive data to/from one or more eNBs 810 or UEs 805, the UEs 805 may include a transmitter/receiver (or alternatively, a transceiver), memory, one or more processors, and/or other like components that enable the UEs 805 to operate in accordance with one or more wireless communications protocols and/or one or more cellular communications protocols. The UEs 805 may have multiple antenna elements that enable the UEs 805 to maintain multiple links 820 and/or sidelinks 825 to transmit/receive data to/from multiple base stations 810 and/or multiple UEs 805. For example, as shown in FIG. 8, UE 805 may connect with base station 810-1 via link 820 and simultaneously connect with UE 805-2 via sidelink 825.

In some implementations, the UEs 805 are configured to use a resource pool for sidelink communications. A sidelink resource pool may be divided into multiple time slots, frequency channels, and frequency sub-channels. In some examples, the UEs 805 are synchronized and perform sidelink transmissions aligned with slot boundaries. A UE may be expected to select several slots and sub-channels for transmission of the transport block. In some aspects, a UE may use different sub-channels for transmission of the transport block across multiple slots within its own resource selection window, which may be determined using packet delay budget information.

In some implementations, the communication system 800 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

In some implementations, the UEs 805 are configured to perform sidelink beam failure recovery procedures. The V2X communication system 800 can enable or disable support of the sidelink beam failure recovery procedures in the UEs 805. More specifically, the V2X communication system 800 can enable or disable support per resource pool or per PC5-RRC configuration (which may depend on UE capability). In the sidelink beam failure recovery procedures, one of the UEs 805 is designated as a transmitter UE (e.g., UE 805-1) and the other UE is designated as a receiver UE (e.g., UE 805-2). For the purposes of this disclosure, a UE that detects a beam failure is designated as the receiver UE and the other UE is designated as the transmitter UE. More generally, a transmitter UE is the UE sending sidelink data, and the receiver UE is the UE receiving the sidelink data. Furthermore, although this disclosure describes a single transmitter UE and single receiver UE, the disclosure is not limited to this arrangement and can include more than one transmitter UE and/or receiver UE.

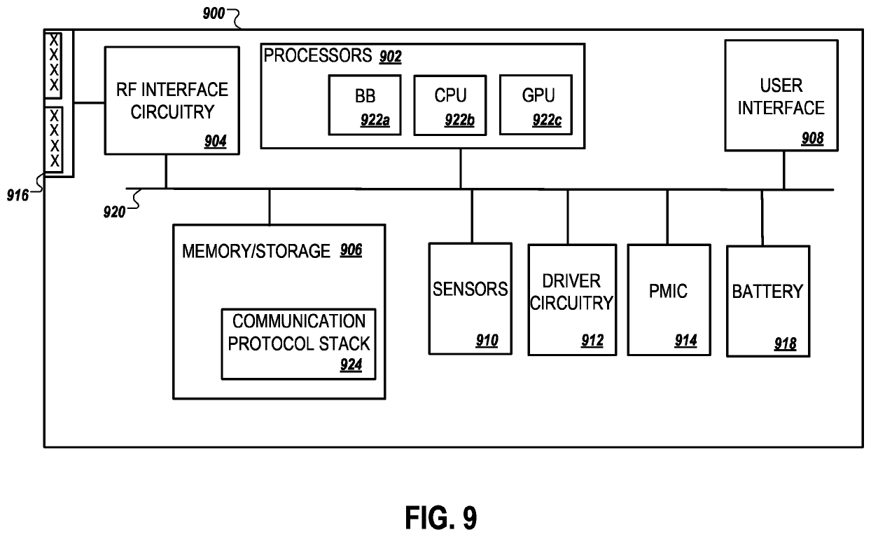

FIG. 9 is a block diagram of an example of user equipment (UE). The UE 900 may be similar to and substantially interchangeable with UEs 805 of FIG. 8.

The UE 900 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 900 may include processors 902, RF interface circuitry 904, memory/storage 906, user interface 908, sensors 910, driver circuitry 912, power management integrated circuit (PMIC) 914, antenna structure 916, and battery 918. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangement of the components shown may occur in other implementations.

The components of the UE 900 may be coupled with various other components over one or more interconnects 920, which may represent any type of interface, input/output, bus (local, system, or expansion), transmission line, trace, optical connection, etc. that allows various circuit components (on common or different chips or chipsets) to interact with one another.

The processors 902 may include processor circuitry such as, for example, baseband processor circuitry (BB) 922A, central processor unit circuitry (CPU) 922B, and graphics processor unit circuitry (GPU) 922C. The processors 902 may include any type of circuitry or processor circuitry that executes or otherwise operates computer-executable instructions, such as program code, software modules, or functional processes from memory/storage 906 to cause the UE 900 to perform operations as described herein.

In some implementations, the baseband processor circuitry 922A may access a communication protocol stack 924 in the memory/storage 906 to communicate over a 3GPP compatible network. In general, the baseband processor circuitry 922A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 904. The baseband processor circuitry 922A may generate or process baseband signals or waveforms that carry information in 3GPP-compatible networks. In some implementations, the waveforms for NR may be based cyclic prefix OFDM “CP-OFDM” in the uplink or downlink, and discrete Fourier transform spread OFDM “DFT-S-OFDM” in the uplink.

The memory/storage 906 may include one or more non-transitory, computer-readable media that includes instructions (for example, communication protocol stack 924) that may be executed by one or more of the processors 902 to cause the UE 500 to perform various operations described herein. The memory/storage 906 include any type of volatile or non-volatile memory that may be distributed throughout the UE 900. In some implementations, some of the memory/storage 906 may be located on the processors 902 themselves (for example, L1 and L2 cache), while other memory/storage 906 is external to the processors 902 but accessible thereto via a memory interface. The memory/storage 906 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 904 may include transceiver circuitry and radio frequency front module (RFEM) that allows the UE 900 to communicate with other devices over a radio access network. The RF interface circuitry 904 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 916 and proceed to filter and amplify (with a low-noise amplifier) the signal. The signal may be provided to a receiver of the transceiver that downconverts the RF signal into a baseband signal that is provided to the baseband processor of the processors 902.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 916.

In various implementations, the RF interface circuitry 904 may be configured to transmit/receive signals in a manner compatible with NR access technologies.

The antenna 916 may include antenna elements to convert electrical signals into radio waves to travel through the air and to convert received radio waves into electrical signals. The antenna elements may be arranged into one or more antenna panels. The antenna 916 may have antenna panels that are omnidirectional, directional, or a combination thereof to enable beamforming and multiple input, multiple output communications. The antenna 916 may include microstrip antennas, printed antennas fabricated on the surface of one or more printed circuit boards, patch antennas, phased array antennas, etc. The antenna 916 may have one or more panels designed for specific frequency bands including bands in FR1 or FR2.

The user interface 908 includes various input/output (I/O) devices designed to enable user interaction with the UE 900. The user interface 908 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 900.

The sensors 910 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 912 may include software and hardware elements that operate to control particular devices that are embedded in the UE 900, attached to the UE 900, or otherwise communicatively coupled with the UE 900. The driver circuitry 912 may include individual drivers allowing other components to interact with or control various input/output (I/O) devices that may be present within, or connected to, the UE 900. For example, driver circuitry 912 may include a display driver to control and allow access to a display device, a touchscreen driver to control and allow access to a touchscreen interface, sensor drivers to obtain sensor readings of sensor circuitry 928 and control and allow access to sensor circuitry 928, drivers to obtain actuator positions of electro-mechanic components or control and allow access to the electro-mechanic components, a camera driver to control and allow access to an embedded image capture device, audio drivers to control and allow access to one or more audio devices.

The PMIC 914 may manage power provided to various components of the UE 900. In particular, with respect to the processors 902, the PMIC 914 may control power-source selection, voltage scaling, battery charging, or DC-to-DC conversion.

In some implementations, the PMIC 914 may control, or otherwise be part of, various power saving mechanisms of the UE 900 including DRX as discussed herein. A battery 918 may power the UE 900, although in some examples the UE 900 may be mounted deployed in a fixed location, and may have a power supply coupled to an electrical grid. The battery 918 may be a lithium ion battery, a metal-air battery, such as a zinc-air battery, an aluminum-air battery, a lithium-air battery, and the like. In some implementations, such as in vehicle-based applications, the battery 918 may be a typical lead-acid automotive battery.

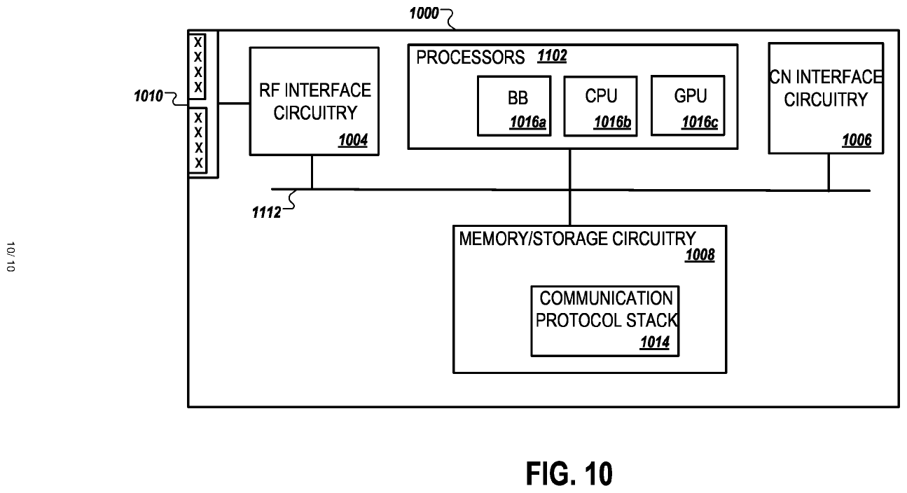

FIG. 10 is a block diagram of an example of an access node. FIG. 10 illustrates an access node 1000 (e.g., a base station or gNB), in accordance with some implementations. The access node 1000 may be similar to and substantially interchangeable with base stations 810. The access node 1000 may include processors 1002, RF interface circuitry 1004, core network (CN) interface circuitry 1006, memory/storage circuitry 1008, and antenna structure 1010.

The components of the access node 1000 may be coupled with various other components over one or more interconnects 1012. The processors 1002, RF interface circuitry 1004, memory/storage circuitry 1008 (including communication protocol stack 1014), antenna structure 1010, and interconnects 1012 may be similar to like-named elements shown and described with respect to FIG. 10. For example, the processors 1002 may include processor circuitry such as, for example, baseband processor circuitry (BB) 1016A, central processor unit circuitry (CPU) 1016B, and graphics processor unit circuitry (GPU) 1016C.

The CN interface circuitry 1006 may provide connectivity to a core network, for example, a 5th Generation Core network (5GC) using a 5GC-compatible network interface protocol such as carrier Ethernet protocols, or some other suitable protocol. Network connectivity may be provided to/from the access node 1000 via a fiber optic or wireless backhaul. The CN interface circuitry 1006 may include one or more dedicated processors or FPGAs to communicate using one or more of the aforementioned protocols. In some implementations, the CN interface circuitry 1006 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1000 that operates in an NR or 5G system (for example, a gNB), and the term “E-UTRAN node” or the like may refer to an access node 1000 that operates in an LTE or 4G system (e.g., an eNB). According to various implementations, the access node 1000 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1000 may be implemented as one or more software entities running on server computers as part of a virtual network, which may be referred to as a CRAN and/or a virtual baseband unit pool (vBBUP). In these implementations, the CRAN or vBBUP may implement a RAN function split, such as a PDCP split wherein RRC and PDCP layers are operated by the CRAN/vBBUP and other L2 protocol entities are operated by the access node 1000; a MAC/PHY split wherein RRC, PDCP, RLC, and MAC layers are operated by the CRAN/vBBUP and the PHY layer is operated by the access node 1000; or a “lower PHY” split wherein RRC, PDCP, RLC, MAC layers and upper portions of the PHY layer are operated by the CRAN/vBBUP and lower portions of the PHY layer are operated by the access node 1000.

In V2X scenarios, the access node 1000 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-10. (canceled)

11. One or more processors configured to, when executing instructions stored in a memory, perform operations comprising:
determining information pertaining to a set of Long Term Evolution (LTE) sidelink resources within a time window associated with a candidate slot that overlaps with at least one LTE sidelink resource in the set of LTE sidelink resources; and
excluding a set of New Radio (NR) sidelink resources from a candidate resource set (SA) during an NR resource selection procedure based at least on the information pertaining to the set of LTE sidelink resources within the time window associated with the candidate slot.

12. The one or more processors of claim 11, wherein excluding the set of NR sidelink resources from the candidate resource set occurs after initializing SA to include a set of resources in an NR resource selection window.

13. The one or more processors of claim 11, wherein excluding the set of NR sidelink resources from the candidate resource set occurs after excluding candidate resources that were not sensed in a sensing window with configured resource reservation periods before a candidate slot.

14. The one or more processors of claim 11, wherein:
excluding the set of NR sidelink resources from the candidate resource set occurs after determining whether to exclude additional candidate resources from SA, and
the one or more processors further comprises determining whether to exclude additional candidate resources from SA after excluding candidate resources that were not sensed in a sensing window with configured resource reservation periods before a candidate slot.

15. The one or more processors of claim 11, wherein excluding the set of NR sidelink resources from the candidate resource set occurs after excluding candidate resources from SA in response to (i) receiving sidelink control information (SCI) that reserves the candidate resources and (ii) determining that a reference signal received power (RSRP) measurement of the candidate resources is higher than an RSRP threshold.

16. The one or more processors of claim 11, wherein excluding the set of NR sidelink resources from the candidate resource set occurs after determining whether a second user equipment (UE) has or will provide preferred or non-preferred resources.

17. The one or more processors of claim 11, wherein excluding the set of NR sidelink resources from the candidate resource set occurs after excluding one or more non-preferred resources provided by a second user equipment (UE) via inter-UE coordination information.

18. The one or more processors of claim 11, wherein excluding the set of NR sidelink resources from the candidate resource set occurs after determining whether a number of resources in SA is smaller than X*Mₜₒₜₐₗ before proceeding with the NR resource selection procedure, wherein Mₜₒₜₐₗ is equal to a number of candidate single-slot resources and X is equal to a configured or preconfigured percentage.

19. The one or more processors of claim 11, wherein the information pertaining to the set of LTE sidelink resources is determined by an LTE module of a user equipment (UE) comprising the one or more processors.

20. The one or more processors of claim 11, wherein the information pertaining to the set of LTE sidelink resources is accessible to an NR module of a user equipment (UE) comprising the one or more processors.

21. The one or more processors of claim 20, wherein the NR module of the UE is configured to determine that the set of NR sidelink resources overlaps with the set of LTE sidelink resources.

22. A method comprising:
determining information pertaining to a set of Long Term Evolution (LTE) sidelink resources within a time window associated with a candidate slot that overlaps with at least one LTE sidelink resource in the set of LTE sidelink resources; and
excluding a set of New Radio (NR) sidelink resources from a candidate resource set (S_{A}) during an NR resource selection procedure based at least on the information pertaining to the set of LTE sidelink resources within the time window associated with the candidate slot.

23. The method of claim 22, wherein excluding the set of NR sidelink resources from the candidate resource set occurs after initializing SA to include a set of resources in an NR resource selection window.

24. The method of claim 22, wherein excluding the set of NR sidelink resources from the candidate resource set occurs after excluding candidate resources that were not sensed in a sensing window with configured resource reservation periods before a candidate slot.

25. The method of claim 22, wherein:
excluding the set of NR sidelink resources from the candidate resource set occurs after determining whether to exclude additional candidate resources from S_{A}, and
the method further comprises determining whether to exclude additional candidate resources from S_{A} after excluding candidate resources that were not sensed in a sensing window with configured resource reservation periods before a candidate slot.

26. The method of claim 22, wherein excluding the set of NR sidelink resources from the candidate resource set occurs after excluding candidate resources from SA in response to (i) receiving sidelink control information (SCI) that reserves the candidate resources and (ii) determining that a reference signal received power (RSRP) measurement of the candidate resources is higher than an RSRP threshold.

27. The method of claim 22, wherein excluding the set of NR sidelink resources from the candidate resource set occurs after determining whether a second user equipment (UE) has or will provide preferred or non-preferred resources.

28. The method of claim 22, wherein excluding the set of NR sidelink resources from the candidate resource set occurs after excluding one or more non-preferred resources provided by a second user equipment (UE) via inter-UE coordination information.

29. The method of claim 22, wherein excluding the set of NR sidelink resources from the candidate resource set occurs after determining whether a number of resources in SA is smaller than X*Mₜₒₜₐₗ before proceeding with the NR resource selection procedure, wherein Mₜₒₜₐₗ is equal to a number of candidate single-slot resources and X is equal to a configured or preconfigured percentage.

30. A user equipment (UE) configured to perform operations comprising:
determining information pertaining to a set of Long Term Evolution (LTE) sidelink resources within a time window associated with a candidate slot that overlaps with at least one LTE sidelink resource in the set of LTE sidelink resources; and
excluding a set of New Radio (NR) sidelink resources from a candidate resource set (S_{A}) during an NR resource selection procedure based at least on the information pertaining to the set of LTE sidelink resources within the time window associated with the candidate slot.
